(19) United States
(12) Patent Application Publication
(10) Pub. No.: US 2012/0086201 A1
(43) Pub. Date: Apr. 12, 2012

(54) DETACHABLE HOSE COUPLING AND STAPLE REMOVER

(76) Inventor: Joseph Stevenson Murken, Springboro, OH (US)

(21) Appl. No.: 12/902,248

(22) Filed: Oct. 12, 2010

(51) Int. Cl. F16L 37/00

(52) U.S. Cl. 285/305

(57) ABSTRACT

A detachable hose coupling includes a generally cylindrical female piece and a male piece having a first end of a size and configuration to permit insertion into the female piece and seat at a fixed point within the female piece, the male piece having a second end for connection to a hose and having a flange collar extending radially outward from the second end and which is longitudinally displaced a predetermined distance from an end of the female piece when said first end of the male piece is completely connected and seated within said female piece, and wherein the flange collar is provided with opposing flats. The female piece includes a notch in one end.

### BACKGROUND OF THE INVENTION

1. Field of Invention

The present invention relates to hose couplings. More particularly, the invention is directed to a detachable hose coupling with an improved female and male coupling having an interlocking U-shaped staple for use in mining and drilling applications and a staple remover.

2. Prior Art

The relevant prior art known is thought to be that of the instant inventor's prior U.S. Pat. No. 6,290,263 issued Sep. 18, 2001 and 6,908,119 issued Jun. 21, 2005. The prior patents are directed to detachable hose couplings having improved interlocking staples and recessed areas to assist with staple removal. These patents provide some significant improvements over the art as stated therein.

Disclosed therein is a detachable hose coupling having improved interlocking U-shaped staple, a female piece, a male piece of a size and configuration to permit insertion into the female piece, wherein the generally U-shaped staple has a cross-section with a peripheral surface which includes at least one radially recessed surface portion.

Also taught was a female piece having a pair of coaxially aligned bored open surfaces which are in opposing generally equidistant positions and displaced from a vertical plane passing through a central longitudinal axis of the female piece. A first grooved surface extended partially into an outer surface of the female piece and extends between the bored open surfaces. A second grooved surface is formed in the outer surface of the female piece and intersects the first grooved surface. The second grooved surface is slightly deeper than the first grooved surface. The female piece has a longitudinal axial open surface extending therethrough in communication with the bored open surfaces. The first grooved surface provides a first line of contact of a first predetermined configuration.

A cylindrical male piece inserted into the female piece and has a longitudinal axial open surface extending therethrough and further has an end configured with an external recessed surface portion which when the male piece is inserted into the female piece is aligned with the bored open surfaces to provide an interconnecting open surface through the detachable hose coupling. The recessed surface provides a second line of contact of a second predetermined configuration in the interconnecting open surface and the bored open surfaces each provide a third and fourth lines of contact of a third and fourth predetermined configuration in the interconnecting open surface. Another end of the male piece is fixably connects to a flexible hose.

A generally U-shaped staple is received through the bored open surfaces of the female piece and about the recessed surface of the male piece while the transverse member generally seats within the first grooved surface to interconnect the male and female piece along the lines of contact. The transverse member is preferably of a configuration such that when seated within the first grooved surface, the transverse member does not substantially extend beyond the outer surface of the female piece. The second grooved surface permits access between the transverse member and the first grooved surface to enable insertion of a pry tool there between and separation of the staple from the male and female pieces.

The staple includes a peripheral surface of a complementary configuration for suitably enabling contact along the lines of contact. The peripheral surface of the staple includes at least one radially recessed surface portion.

Though the prior art improved upon the coupling designs in the mining field, there remains a need to improve detachable hose couplers. The present invention thus provides an improvement over the art.

### SUMMARY OF THE INVENTION

It is an object of the invention to improve detachable hose couplings in the field of drilling and mining.

It is a further object to improve a male coupler for use with a female coupler and an interlocking U-shaped staple in a detachable male-female hose coupling.

It is also an object to provide a removal tool for use with female-mail couplings.

Accordingly, the present invention is directed a detachable hose coupling having an improved male coupler piece. The coupling includes a generally cylindrical female piece of the type described in the inventor's prior patents save for the inclusion of a notch in an end thereof to aid in removal separating the male and female pieces. The female coupling can include a t-shaped channel formed in the outer surface which extends between the bore surfaces.

The male coupling can include features of the type previously described. The improvement of the male coupling includes a generally male piece which is of a size and configuration to permit insertion into the female piece and to seat at a fixed point within the female piece such that a flange collar provided with opposing flats extends radially outward from the male piece is longitudinally displaced a predetermined distance from an end of the female piece when the male piece is completely connected and seated within the female piece. Thus, the predetermined distance is provided between the flange collar and the end of the female piece to enable a novel tool which is provided to easily separate the male and female pieces. Further, the flange collar permits side by side connections of male couplings when coupling to a manifold where minimal clearance is required. Thus the male piece has multiple uses and applications for “in use” as well as “transportation.”

A novel staple is also provided wherein the staple is U shaped having legs which can preferably be offset from one another in a non-coplanar relation. Further, the legs can include an arcuate portion to interfere with a vertical bore hole of the female coupling and thereby aid in staple retention therein. The staple wave form also provides for improved male coupling retention with additional contact area of the outer diameter of the male coupling.

The male piece, female piece or staple can also be magnetized to aid in retention. A surface of one or both legs of the staple can include a knurl such that once the staple is forced into the coupling upon removal, the knurl is visibly deformed thereby indicating a use of the staple. The staple includes a radius to fit between bore holes of the female body.

In accordance with another embodiment of the invention, there is provided a removal tool for use with the detachable hose coupling. The removal tool includes a forked end having a tapered thickness with an outermost end of the forked end having a thickness less than that of the predetermined distance between the flange and end of female piece to readily enable insertion therebetween. The tool has another end with an enlarged radius which is blunt and includes a laterally extending tapered member which terminates in a wedge to enable insertion between the staple and the female piece to enable removal of the staple from the coupling. The laterally extending tapered end can include a notch which is configured to receive a transverse cross section of the staple. A slide handle is provided on a mid portion of the tool to enable improved use for either end of the tool.

### BRIEF DESCRIPTION OF THE DRAWINGS

FIG. 1 is a side view of the present invention.

FIG. 2 is a side view of the present invention with a partial sectional cut-away.

FIG. 3 is a cross-section through line 3-3 of FIG. 2.

FIG. 4 is a side view of another embodiment of the present invention.

FIG. 5 is a side view of the embodiment in FIG. 4 shows a female piece in cross section.

FIG. 6A is a perspective view of a male piece of the coupling of the instant invention.

FIG. 6B is a perspective view of another male piece of the coupling of the instant invention.

FIG. 7A is a side view of a staple of the coupling of the instant invention.

FIG. 7B is a side view of another staple of the coupling of the instant invention.

FIG. 7C is a cross section of the staple of the instant invention through line 7C-7C.

FIG. 8 is a cross section of another embodiment.

FIG. 8A is an exploded portion of FIG. 8.

### DETAILED DESCRIPTION OF THE PREFERRED EMBODIMENTS OF THE INVENTION

Referring now to the drawings, the detachable hose coupling is generally referred to by the numeral 10 and the associated removal tool 100. The hose coupling 10 is of the type for use in the drilling and mining industries to couple hydraulic fluid hose, but may have other uses.

The coupling 10 includes a generally cylindrical female piece 12 having a pair of coaxially aligned bored open surfaces 14 and 16 and which are in generally equidistant opposing positions about a vertical plane P passing through the center of a longitudinal axis A of the coupling 10 and are disposed at one end of the piece 12. The piece 12 has grooved surface 15 which extend partially into an outer surface of the piece 12 and extends between the bored open surfaces 14 and 16. Second grooved surface 17 is formed in the outer surface of the piece 12 and intersects grooved surface 15, here shown at about 90 degrees on center. Together the grooved surfaces 15 and 17 form a T-shape. The orientation of the grooved surfaces 15 and 17, for example, can vary, but the particular orientation provides one exemplary access way and as will be apparent other variations may be employed. Also, grooved surface 17 is slightly deeper than the grooved surface 15 for use with tool 100 as will be described hereinafter. A notched surface 19 is provided in end 21 of piece 12 to aid in separating the female piece 12 from male piece 28′.

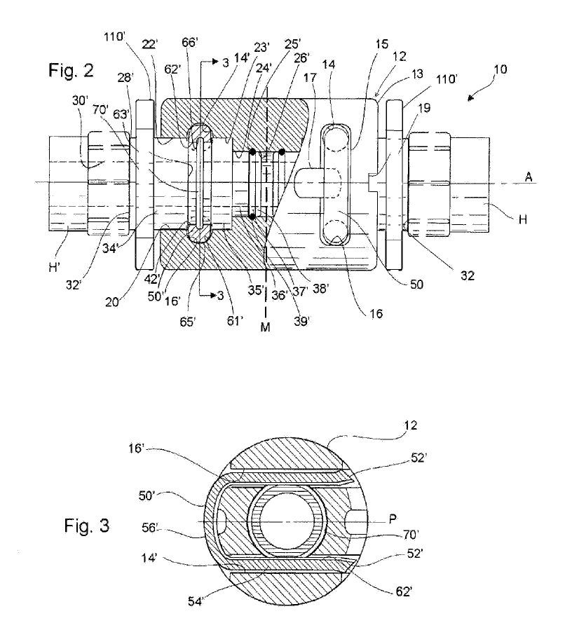

The piece 12 includes a longitudinal inner open surface 20 which axially extends throughout the piece 12. The inner open surface 20 includes surface portions 22′ and 23′ about bored open surfaces 14′ and 16′, and reduced annular surfaces 24′, 25′ and 26′ and all of which exist on both sides of the mid-line M, but only half are shown in the cut-away of FIG. 2.

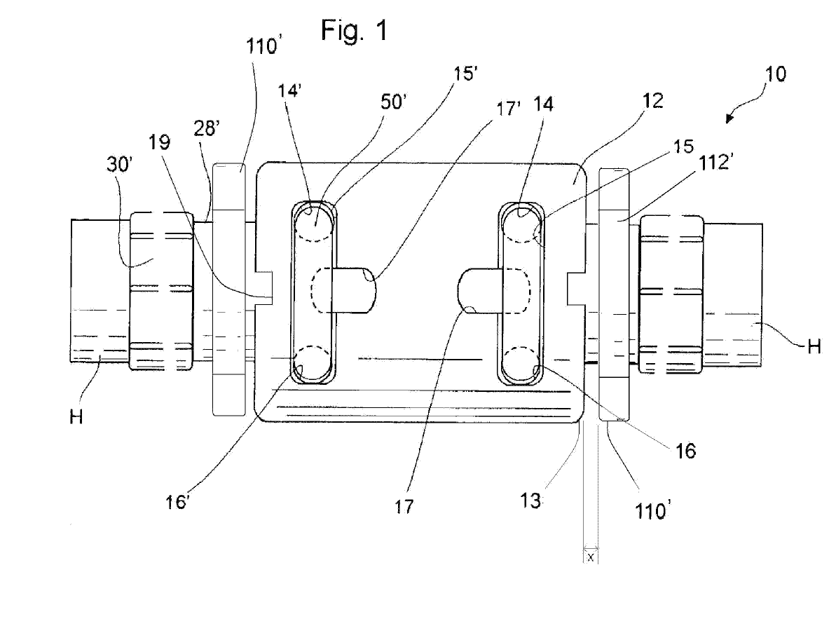

The coupling 10 also includes a generally cylindrical male piece 28′. The piece 28′, for example, has an open surface 30′ axially extending longitudinally therethrough to permit fluid communication therethrough with hose H′. In FIGS. 1 and 2, two male pieces 28 and 28′ can be employed in the piece 12. The male piece 28′ has one end 32′ connected to hose H′ and another end 34′ to be received approximately half way within the female piece 12.

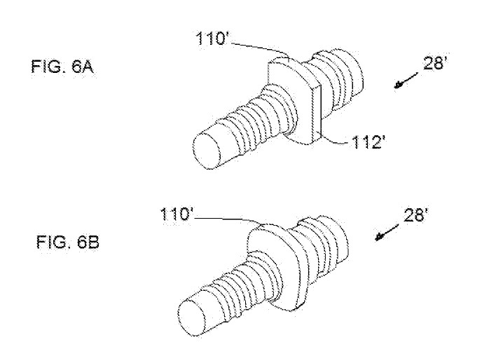

A flange 110′ flange collar extends radially outward from the male piece 28 or 28′ and is longitudinally displaced a predetermined distance X from an end 13 or 13′ of the female piece 12 or 12′ when the male piece 28 or 28′ is completely connected and seated within the female piece 12 or 12′. Thus, the predetermined distance X is provided between the flange collar 110′ and the end 13 or 13′ of the female piece 12 or 12′ to enable a novel tool which is provided to easily separate the male and female pieces. Further, the flange collar 110′ in the preferred embodiment the flange collar is provided with opposing flats 112′ as seen in FIG. 6A which permit side by side connections of male pieces 28′ when connected to a manifold (not shown) wherein minimal side by side clearance is required. The flange collar 110′ can be provided without opposing flats 112′ as seen in FIG. 6B and used in conjunction with the notched surface 19 of female piece 12. Thus the male pieces 28, 28′ have multiple uses and applications for “in use” as well as “transportation.” The flange collars 110′ together with notch 19 provide surfaces for leveraging against with tool 100 in order to gain separation of the male and female pieces 12 and 28 (12′ and 28′).

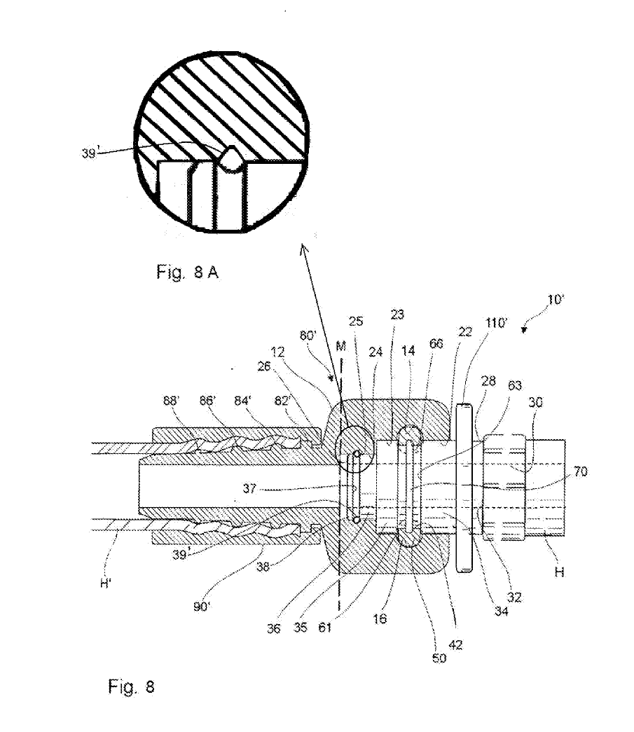

The end 34′ includes external surface portions 35′, 36′, 37′ and 38′ which are of a lesser diameter than annular surfaces 23′, 24′, 25′ and 26′, respectively, to permit slidable receipt of the male piece 28′ into the piece 12. An O-ring 39 is also provided and seats between surfaces 25′ and 37′. As can be seen in FIGS. 8 and 8A, the O-ring 39′ can preferably be of a V-shape outer peripheral configuration to aid against spiraling and flattening as with conventional O-rings. Additionally, the O-ring 39′ can be color coded corresponding to operating pressure requirements. The end 34′ also includes an external cylindrical recessed surface 42′ which, when the male piece 28′ is inserted into the piece 12, generally aligns between the surface portions 22′ and 23′.

As seen in FIGS. 1 and 2, two staples 50 and 50′ are provided to interconnect the female piece 12 and male pieces 28, 28′. The staples 50 and 50′ can be generally U-shaped having slightly outwardly flared ends 52 and 52′. FIG. 2 depicts the recessed surface 42′ including a radially protruding guide surface 70′ on the male piece 28′.

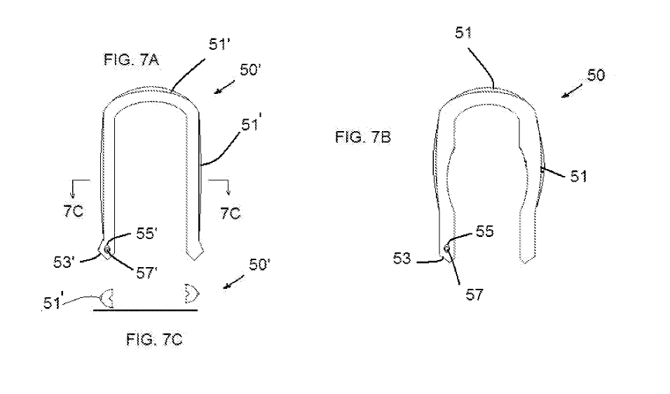

It is contemplated that various configurations of the staple can be employed to carry out the invention and should be included in the scope of the appended claims. By way of example, a cross-sectional configuration of the U-shaped staple 50, 50′ is preferably formed having an exterior surface configured with contact points minimizing brinelling of surface portions 61, 61′ and 63, 63′. In FIG. 2, the U-shaped staple 50′ of the type shown in FIG. 7A is shown configured with a cross sectional design having at least one linear flat surface 62′ for disposal adjacent the cylindrical external recessed surface 42′ of a male coupling piece 28′ and has a radial arcuate surface 65′ for disposal adjacent the generally arcuate surface 61′. As seen in FIG. 2, a radially recessed surface portion 66′ is configured to receive the surface 70′. The U-shaped staple 50′ is configured with two opposing arms 54′ and an interconnecting transverse member 56′. The arms 54′ are configured to be received through the bored open surfaces 14′ and 16′ of the female piece 12 and about the recessed surface 42′ of the male piece 28′ while the transverse member 56′ generally seats within the grooved surface 15′ to interconnect the male piece 28′ and female piece 12 along lines of contact between the grooved surface 15′ and transverse member 56′, arms 54′ and bored open surfaces 14′ and 16′ and recessed surface 42′. The transverse member 56′ is preferably of a configuration such that when seated within the 15′ grooved surface, the transverse member 56′ does not substantially extend beyond the outer surface of the female piece 12. In this regard, the depth of the grooved surface 15′ should be sufficient to generally accommodate the receipt of the member 56′.

FIG. 7B provides an alternative design of staple 50. Here, the staple 50 include a wave formed arms 54 designed to lock onto corresponding male piece 28. The wave formed arms 54 improve linear and peripheral contact area of the diameter of the male piece 28. In turn, there is provided a better retention between parts. As seen in FIG. 7c, the arms 54 or 54′ can be offset. Once driven into the coupling 10, there is improved dynamic performance.

One or more surfaces 51, 51′ of the staple 50, 50′ can be knurled to improve retention and upon removal provide a visual indicator of its use and aid in retention. An end 53, 53′ can include an opening 55, 55′ and hitch pin 57, 57′ which can be used to secure the staple 50, 50′. Additionally, the staple 50, 50′ can be magnetized to improve retention.

The intersecting grooved surface 17′ is slightly deeper than the grooved surface 15′ to permit access between the transverse member 56′ and the grooved surface 17′ to enable insertion of a pry tool 100 there between in order to separate the staple 50′ from the male piece 28′ and female piece 12.

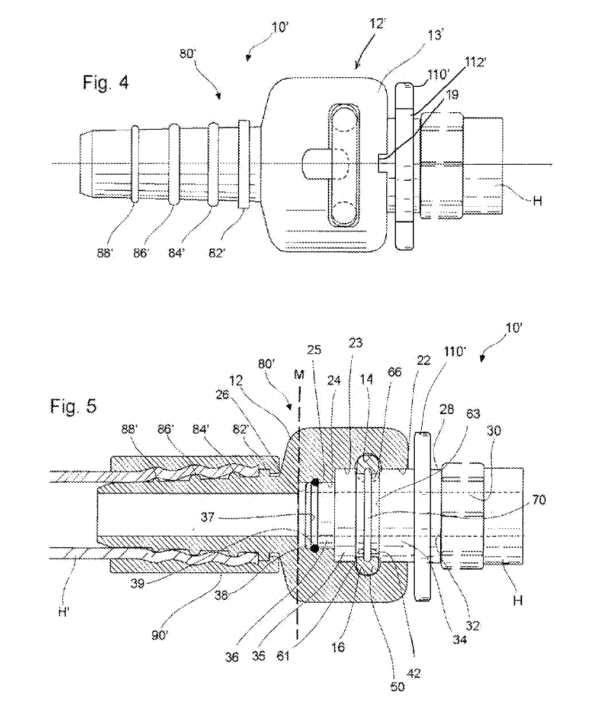

FIGS. 4 and 5 show another embodiment 10′. Here, the piece 12′ includes like features described above on one side of the median line M and one its other side includes a male insert end 80′ which includes a plurality of radial protruding surfaces 82′, 84′, 86′ and 88′ which aid in hose retention. The end 80′ is tapered to ease insertion into hose H′, which can be held on to the end 80′ by a ferrule 90′ which is crimped or otherwise mechanically locked about the hose H′.

The present invention provides for an increased plurality of lines of contact between the staple 50 and the male piece 28 and female piece 12, for example. The increased contact points further assure the retention between parts. In addition, the invention provides for ease of separation of parts by virtue of the new features described herein.

In accordance with another embodiment of the invention, there is provided a removal tool 100 for use with the detachable hose coupling. The removal tool includes a forked end having a tapered thickness with an outermost end of the forked end having a thickness less than that of the predetermined distance between the flange and end of female piece to readily enable insertion therebetween. The tool has another end with an enlarged radius which is blunt and includes a laterally extending tapered member which terminates in a wedge to enable insertion between the staple and the female piece to enable removal of the staple from the coupling. The laterally extending tapered end can include a notch which is configured to receive a transverse cross section of the staple. A slide handle is provided on a mid portion of the tool to enable improved use for either end of the tool.

The above described embodiments are set forth by way of example and are not for the purpose of limiting the present invention. It will be readily apparent to those skilled in the art that obvious modifications, derivations and variations can be made to the embodiments without departing from the scope of the invention. Accordingly, the claims appended hereto should be read in their full scope including any such modifications, derivations and variations.

What is claimed is:

1. A detachable hose coupling, which includes
a generally cylindrical female piece; and
a male piece having a first end of a size and configuration to permit insertion into the female piece and seat at a fixed point within the female piece, said male piece having a second end for connection to a hose and having a flange collar extending radially outward from said second end and which is longitudinally displaced a predetermined distance from an end of the female piece when said first end of said male piece is completely connected and seated within said female piece, and wherein said flange collar is provided with opposing flats.

2. The detachable hose coupling of claim 1, wherein said end of said female piece includes a notch surface opposing said flange collar.

3. The detachable hose coupling of claim 1, wherein said female piece has a pair of coaxially aligned bored open surfaces which are in opposing generally equidistant positions and displaced from a vertical plane passing through a central longitudinal axis of the female piece, and a longitudinal axial open surface extending through said female piece in communication with said bored open surfaces, and said male piece has a longitudinal axial open surface extending through said male piece and further includes an external recessed surface portion which when said male piece is inserted into said female piece is generally alignable with said bored open surfaces to provide an interconnecting open surface through said detachable hose coupling, and a generally U-shaped staple configured with two opposing arms and an interconnecting transverse member, wherein said arms are configured to be received through said bored open surfaces of said female piece and about said recessed surface of said male piece to interconnect said male piece and said female piece along lines of contact between said first grooved surface, said transverse member, said arms, said bored open surfaces and said recessed surface.

4. The detachable hose coupling of claim 3, which further includes a first grooved surface extends partially into an outer surface of said female piece and extends between said bored open surfaces and said transverse member generally seats within said first grooved surface.

5. The detachable hose coupling of claim 4, which further includes a second grooved surface which extends partially into an outer surface of said female piece and which intersects said first grooved surface to permit access between said transverse member and said first grooved surface in a manner to enable insertion of a pry tool there between for separation of said staple piece and said female piece, wherein said second grooved surface extends deeper into said outer surface of said female piece than the first grooved surface.

6. The detachable hose coupling of claim 3, wherein said staple includes arms which are in offset relation to a common plane passing through said arms.

7. The detachable hose coupling of claim 3, wherein said staple includes a knurled surface.

8. The detachable coupling of claim 5, wherein said transverse member is of a configuration such that when seated within said first grooved surface, said transverse member does not substantially extend beyond the outer surface of the female piece.

9. The detachable coupling of claim 3, wherein one of said female piece, said male piece and said U-shaped staple is magnetized.

10. A detachable hose coupling, which includes
a generally cylindrical female piece includes a notch in one end; and
a male piece having a first end of a size and configuration to permit insertion into the female piece and seat at a fixed point within the female piece, said male piece having a second end for connection to a hose and having a flange collar extending radially outward from said second end and which is longitudinally displaced a predetermined distance from an end of the female piece when said first end of said male piece is completely connected and seated within said female piece, and wherein said notch surface opposes said flange collar.

11. The detachable hose coupling of claim 10, wherein said flange collar is provided with opposing flats.

12. The detachable hose coupling of claim 11, The detachable hose coupling of claim 1, wherein said end of said female piece includes a notch surface opposing said flange collar.

13. The detachable hose coupling of claim 10, wherein said female piece has a pair of coaxially aligned bored open surfaces which are in opposing generally equidistant positions and displaced from a vertical plane passing through a central longitudinal axis of the female piece, and a longitudinal axial open surface extending through said female piece in communication with said bored open surfaces, and said male piece has a longitudinal axial open surface extending through said male piece and further includes an external recessed surface portion which when said male piece is inserted into said female piece is generally alignable with said bored open surfaces to provide an interconnecting open surface through said detachable hose coupling, and a generally U-shaped staple configured with two opposing arms and an interconnecting transverse member, wherein said arms are configured to be received through said bored open surfaces of said female piece and about said recessed surface of said male piece to interconnect said male piece and said female piece along lines of contact between said first grooved surface, said transverse member, said arms, said bored open surfaces and said recessed surface.

14. The detachable hose coupling of claim 13, which further includes a first grooved surface extends partially into an outer surface of said female piece and extends between said bored open surfaces and said transverse member generally seats within said first grooved surface.

15. The detachable hose coupling of claim 14, which further includes a second grooved surface which extends partially into an outer surface of said female piece and which intersects said first grooved surface to permit access between said transverse member and said first grooved surface in a manner to enable insertion of a pry tool there between for separation of said staple piece and said female piece, wherein said second grooved surface extends deeper into said outer surface of said female piece than the first grooved surface.

16. The detachable hose coupling of claim 13, wherein said staple includes arms which are in offset relation to a common plane passing through said arms.

17. The detachable hose coupling of claim 13, wherein said staple includes a knurled surface.

18. The detachable coupling of claim 14, wherein said transverse member is of a configuration such that when seated within said first grooved surface, said transverse member does not substantially extend beyond the outer surface of the female piece.

19. The detachable coupling of claim 13, wherein one of said female piece, said male piece and said U-shaped staple is magnetized.

20. The detachable hose coupling of claim 1, which includes an O-ring operably disposed on said first end of said male piece, wherein said O-ring has an outer V-shape configuration.

21. The detachable hose coupling of claim 1, wherein said O-ring is color coded corresponding to a predetermined operating pressure.

22. The detachable hose coupling of claim 10, which includes an O-ring operably disposed on said first end of said male piece, wherein said O-ring has an outer V-shape configuration.

23. The detachable hose coupling of claim 22, wherein said O-ring is color coded corresponding to a predetermined operating pressure.
